(19) United States
(12) Patent Application Publication
(10) Pub. No.: US 2026/0340725 A1
(43) Pub. Date: Oct. 29, 2026

(54) System and Method for Integrating a Traditional Financial Exchange and an Exchange on a Blockchain

(71) Applicant: MVGX Tech Pte. Ltd., Singapore (SG)

(72) Inventor: Bo Bai, Singapore (SG)

(21) Appl. No.: 19/103,865

(22) PCT Filed: Aug. 15, 2022
(86) PCT No.: PCT/SG2022/050580

§ 371 Date: Feb. 14, 2025

(51) Int. Cl. G06Q 40/04

(52) U.S. Cl. CPC G06Q 40/055

(57) ABSTRACT

A method for interfacing a digital financial exchange and a distributed ledger system is described. In response to a listing request to list a quantity of trading units of a tradeable asset on a digital financial exchange, an equivalent quantity of tokens are generated in a distributed ledger. The quantity of tokens is paired with the quantity of trading units to create an equivalent quantity of trading unit token pairs. Either the token to allow trading of the paired trading unit on the digital financial exchange or the trading unit to allow trading of the paired token on the distributed ledger is stored. It is then determined whether the trading unit is in the custody or the token is in the custody, and if the token is in the custody then placing the associated trading unit in the custody and releasing the token for trading on the distributed ledger, and if the trading unit is in the custody then placing the associated token in the custody and releasing the trading unit for trading on the financial exchange.

### CROSS-REFERENCE TO RELATED APPLICATION

This application is the United States national phase of International Patent Application No. PCT/SG2022/050580 filed Aug. 15, 2022, the disclosure of which is hereby incorporated by reference in its entirety.

### BACKGROUND OF THE INVENTION

### Field of the Invention

The present application relates to trading systems and in particular to systems and methods for trading assets between financial exchanges and distributed ledger/blockchain based trading platforms.

### Description of Related Art

Financial exchanges allow parties to trade and exchange a range of tradeable assets such as securities (e.g. shares in a company, financial instruments), commodities (e.g. iron ore, wheat), foreign exchange, futures, and options contracts. Typically, rather than listing and trading the entire asset, the asset is represented by a fixed number of units, each of which may be individually traded. For example a company may issue a fixed number of shares and then allow traders to buy and sell one or more shares on the financial exchange. For the sake of convenience, the term tradeable unit is used to collectively refer to units of any of the tradeable assets which may be traded on a financial exchange.

Most financial exchanges are regulated and control the listing and trading process according to agreed rules and regulations. The listing process involves submission of relevant documents and information from the asset owner regarding the asset to be listed which is then reviewed and approved by the financial exchange and sometimes further by the regulator overseeing the exchange. Once approved the tradeable units are listed on the exchange for purchase by traders. A custodian may be used to hold the records of the tradeable asset listings and ownership details (e.g. electronic share certificates). Modern financial exchanges are largely computational (i.e. digital/electronic) systems which provide a digital trading platform that provides a computational interface to receive buy and sell offers for tradeable units from traders. The digital trading platform matches buy and sell offers and actions the trade, and then clearing and settlement is performed. The clearing and settlement manages exchange of payments and updating of ownership of the traded unit on an electronic ledger or database. This may be performed by the digital trading platform itself, or typically by third party clearing house. The third party clearing house may be the custodian and may be an automated clearing house. The asset owner can also request a trading halt on the exchange which prevents further trading of the tradeable units issued in relation to the asset whilst the trading halt is in force. A trading halt may also be initiated by the financial exchange.

In recent times distributed ledgers such as those based on blockchain technologies have been developed that allow trading of cryptocurrencies and other cryptographic backed assets such as Non Fungible Tokens (NFTs). A blockchain is a distributed ledger operating on a peer to peer network and is formed of cryptographic blocks, where each block contains a cryptographic hash of the previous block (thus forming a chain of blocks), along with a time stamp and transaction data. Blockchains operate as a distributed and decentralized system, with each node having a copy of the blockchain (distributed ledger). Adding a transaction requires each node to check the validity of the transaction and transactions are only added if a majority of nodes agree the transaction is valid (consensus). Transactions and data on a blockchain are effectively immutable, or at least extremely resistant to modification, as it requires a majority of the distributed nodes (or more specifically the blocks on the local copy of the blockchain) to be altered. Blockchains are typically public but can be private.

Cryptocurrencies are digital currencies created (or mined) on an underlying blockchain which is also used to store coin ownership information and process transactions (i.e. transfer of ownership of a coin from one party to another). Popular cryptocurrencies include Bitcoin which is generated and traded on the bitcoin network (also referred to as the bitcoin blockchain) and Ether which is generated and traded on the Ethereum blockchain. In each case the underlying blockchain records transactions which are verified using public-private key cryptography. Each coin is stored at a unique address on the blockchain which is based on (or is) a public key of the coin owner and which can be transferred with knowledge of the associated private key. For example in the bitcoin network a bitcoin address is generated by applying a double hashing function to the public key associated with the coin.

The coin owner can transfer a coin to another party (the new owner) by generating a transaction which is digitally signed using the associated private key, and the transaction is then broadcast to the network for verification and subsequent writing to the blockchain in a new block. For example a bitcoin transaction comprises one or more inputs comprising the addresses (public keys) of any bitcoin to transferred, the amount to be transferred, and at least two outs comprising the address (public key) of the new owner, and an address (public key) where any change is to be stored. The new owner will know the private key associated with the new address and the previous owner will know the private key of the address for any change that is stored. This allows bitcoins to be split and a single transaction to pay multiple parties.

When a transaction is broadcast the digital signature and public key (coin address) are used by miners (or others) to verify the transaction is valid. The miners then group a set of transactions into a block and perform a proof of work calculation. The first miner to first successfully complete the proof of work calculation then broadcasts the new block to the network. Each node verifies the transactions in the new block, and then adds it to their local copy of the blockchain, and rebroadcasts it to other nodes so that the block propagates across the network. As new blocks are written to the network they are chained to this block effectively confirming the transactions present. In return for completing the proof of work, the miner is rewarded with new coins as well as any transaction fees associated with the transactions in the new block. When written to the blockchain the transaction is linked to the previous transaction allow chain of ownership to be verified back to the point of mining. In bitcoin the difficulty of the proof of work calculation is periodically adjusted to maintain an approximately constant mining rate of one new block every 10 minutes. The hashrate is how much computing power is being used by the miners in a network to process transactions. The higher the hashrate, the more difficult and costly it is for someone to attack the network.

Blockchain transactions are thus automated and can be settled in minutes or hours rather than days compared with traditional financial exchanges. For example blocks on the Bitcoin network are validated approximately every 10 minutes whilst Ethereum blocks are validated approximately every 12 seconds. This is much faster than the 2-day settlement of conventional exchanges. The use of public-private key cryptography prevents unauthorized spending of coins. Traders only need to know the private key of a coin to use it. That is whoever holds the private key has control of the associated coin. Accordingly cryptocurrency traders typically store the private keys of their coins in a digital wallet. Some traders use cold wallets which are offline storage devices such as a USB or laptop. The cold wallet is then only connected to the network in order to initiate or receive a transaction.

In addition to trading of cryptocurrencies, blockchains are also used to store and execute smart contracts. Smart contracts are code stored on the blockchain (e.g. a stored procedure) which when provided with appropriate inputs triggers automatic execution of the smart contract and the results are written to the blockchain. The Ethereum blockchain is one example of a blockchain that was specifically developed to support smart contracts. One use of a smart contract is to create Non Fungible Tokens (NFTs) which are associated with, or used to record ownership of, digital assets such as artworks. Unlike cryptocurrencies in which all coins or tokens are fungible (i.e. identical or mutually interchangeable), an NFT is a unique representation of the digital asset. In the Ethereum blockchain, NFTs are created using smart contracts such as those based on ERC 721 which creates a unique digital identifier (or token) which can be associated with a digital asset to establish (and prove) unique ownership of the digital asset. The ERC 721 definition also provides methods for transfer of the asset to another party. Other blockchains define similar smart contracts and methods for creating NFTs. There have also been some attempts to use NFTs to represent real world objects, by representing a real world object with a digital twin in the form an NFT that stores details of the object. For example in a manufacturing process, a digital twin can be created for each part to provide traceability or prove provenance.

However a divide exists between financial exchanges used for trading conventional assets and distributed ledgers for trading cryptographic backed assets, and it is not possible to trade an asset between the two exchanges. There is thus a need to create systems and method for providing an interface between financial exchanges and distributed ledgers.

### SUMMARY OF THE INVENTION

According to a first aspect, there is provided a method for interfacing between a first exchange and a second exchange, comprising:
generating a plurality of trading units for trading on a first exchange and a plurality of tokens for trading on a second exchange, and pairing the plurality of trading units with the plurality of tokens to create a plurality of trading unit token pairs;
placing in a custody, for each of the plurality of trading unit token pairs, either the token to allow trading of the paired trading unit on the first exchange or the trading unit to allow trading of the paired token on the second exchange;
receiving one or more platform switching requests for a trading unit token pair and for each trading unit token pair determining whether the trading unit is in the custody or the token is in the custody, and if the token is in the custody then placing the associated trading unit in the custody and releasing the token for trading on the second exchange, and if the trading unit is in the custody then placing the associated token in the custody and releasing the trading unit for trading on the first exchange.

In one form, the first exchange is a digital financial exchange and the plurality of trading units are N trading units which are generated in response to a listing request to list N trading units of a tradeable asset on the digital financial exchange, and approval of the listing requests triggers generating N tokens on the second exchange. In a further form, the second exchange is a distributed ledger and the plurality of tokens are N tokens generated by a smart contract executing on the distributed ledger.

In one form, the second exchange is a distributed ledger and the plurality of tokens are N tokens generated by a smart contract executing on the distributed ledger in response to a first listing request to list N tokens of a tradeable asset on the distributed ledger, and approval of the listing request triggers generating N trading units on the first exchange. In a further form, the first exchange is a digital financial exchange and a second listing request is made to the digital financial exchange to generate the N trading units for trading on the digital financial exchange.

In one form, either the first exchange or the second exchange is an Ethereum blockchain and the tokens are ERC-20 tokens generated by ERC-20 Token Smart Contract or a Smart Contract compliant with the ERC-20 Token standard.

In one form, pairing the plurality of trading units with the plurality of tokens to create a plurality of trading unit token pairs comprises pairing each token with one of the trading units. In one form, the custody comprises a cold wallet to store each token held in custody and each trading unit held in custody. In one form, the custody uses a cryptographic function to generate a public signature for each token or trading unit held in custody which is used to verify that the pair of a trading unit or token that is released for trading is held in the custody.

In one form, the method further comprises generating a NFDT on a distributed ledger to represent the tradeable asset, wherein the NFDT is configured to store a representation of the asset, a quantity of trading unit token pairs and a trading status for each trading unit token pair indicating which member of the pair is currently being traded, and the platform switching requests.

In one form, in response to receiving a platform switching request for a first quantity of trading units of the trading unit token pairs that is being traded on the first exchange, a request is sent to the first exchange to lock trading of the first quantity trading units on the first exchange, and once confirmation of locking of trading of the first quantity of trading units is received from the first trading exchange, the first quantity of trading units are placed in the custody and the associated first quantity of tokens are released from the custody. In one form, in response to receiving a platform switching request for a second quantity of tokens of the trading unit token pairs that is being traded on the second exchange, a request is made to the first exchange for the switch from trading tokens to trading units and once confirmation is received from the first exchange the second quantity of tokens are placed in the custody and the second quantity of trading units are released from the custody for trading on the first exchange by the token holder who becomes the holder of the trading unit on the first exchange.

According to a second aspect, there is provided a computational system for interfacing a first exchange and a second exchange comprising a plurality of computing apparatus each comprising at least one memory and at least one processor, and a custody storage wherein the computational system is configured to:
generate a plurality of trading units for trading on a first exchange and a plurality of tokens for trading on a second exchange, and pairing the plurality of trading units with the plurality of tokens to create a plurality of trading unit token pairs;
store in the custody storage, for each of the plurality of trading unit token pairs, either the token to allow trading of the paired trading unit on the first exchange or the trading unit to allow trading of the paired token on the second exchange;
receive one or more platform switching requests for a trading unit token pair and for each trading unit token pair determining whether the trading unit is in the custody or the token is in the custody, and if the token is in the custody then placing the associated trading unit in the custody and releasing the token for trading on the second exchange, and if the trading unit is in the custody then placing the associated token in the custody and releasing the trading unit for trading on the first exchange.

In one form, the distributed ledger is the Ethereum blockchain and the tokens are ERC-20 tokens generated by ERC-20 Token Smart Contract or a Smart Contract compliant with the ERC-20 Token standard.

In one form, the custody storage comprises a cold wallet to store each token held in the custody storage and each trading unit held in the custody storage.

In one form, the computational system is further configured to generate a NFDT on the distributed ledger to represent the tradeable asset, wherein the NFDT is configured to store a representation of the asset, a quantity of trading unit token pairs and a trading status for each trading unit token pair indicating which member of the pair is currently being traded, and the platform switching requests.

In one form, in response to receiving a platform switching request for a first quantity of trading units of the trading unit token pairs that is being traded on the first exchange, a request is sent to the first exchange to lock trading of the first quantity of trading units on the first exchange, and once confirmation of locking of trading of the trading units is received from the first trading exchange, the first quantity of the trading units are placed in the custody and the associated first quantity of tokens are released from the custody. In one form, in response to receiving a platform switching request for a second quantity of tokens of the trading unit token pairs that is being traded on the second exchange, a request is made to the first exchange for a switch from trading tokens to trading units and once confirmation is received from the first exchange the second quantity of tokens are placed in the custody and the second quantity of trading units are released from the custody for trading on the first exchange by the token holder who becomes the holder of the trading unit on the first exchange.

According to a third aspect, there is provided a non-transitory computer readable medium comprising instructions for configuring a computational system to perform the method of the first aspect.

### BRIEF DESCRIPTION OF THE DRAWINGS

Embodiments of the present disclosure will be discussed with reference to the accompanying drawings wherein:

FIG. 1 is a schematic diagram of a system for interfacing a first exchange and a second exchange according to an embodiment; and

FIG. 2 is a flowchart of a method for interfacing a first exchange and a second exchange according to an embodiment.

In the following description, like reference characters designate like or corresponding parts throughout the figures.

### DESCRIPTION OF THE INVENTION

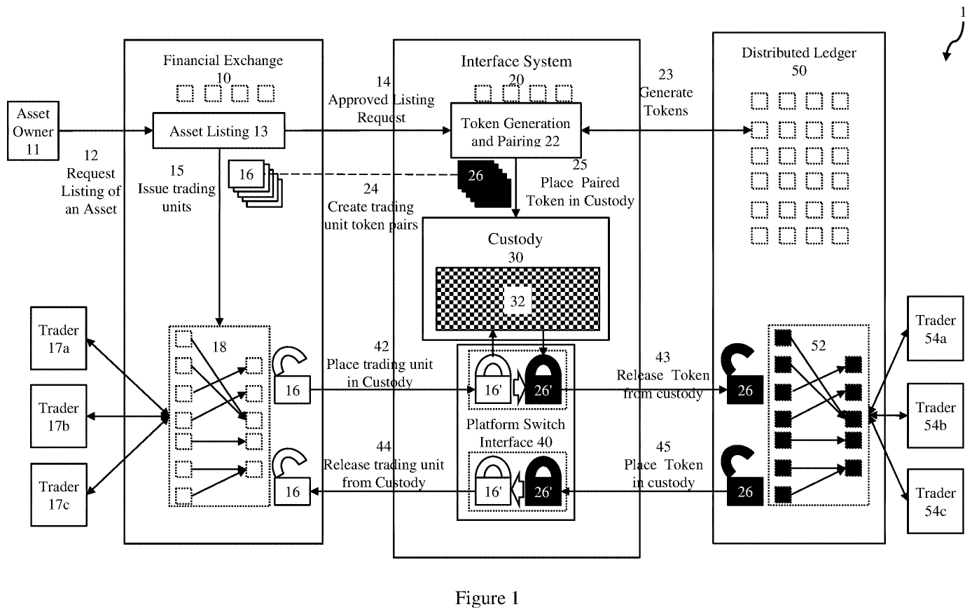

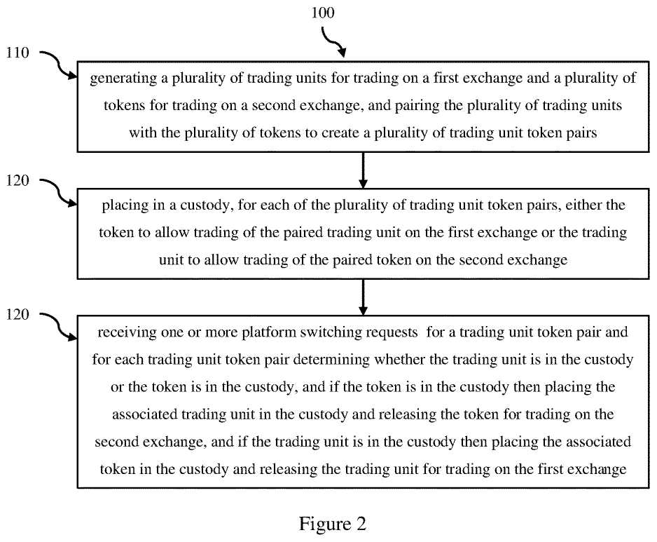

FIG. 1 is a schematic diagram of a computational system 1 for interfacing a first exchange 10 and a second exchange 50 according to an embodiment and FIG. 2 is a flowchart of a method 100 for interfacing a first exchange and a second exchange according to an embodiment. Embodiments of the method provide an interface system 20 between the first exchange 10 and the second exchange 50 which allows cross platform trading of assets between the two platforms to effectively link the two separate platforms. In some embodiments the first exchange is a traditional financial exchange, i.e. an off blockchain platform (although it may still be a digital exchange), and the second exchange is a distributed ledger platform or automated market making platform, i.e. an on blockchain platform.

To illustrate the system and interfacing method in FIG. 1, the first exchange 10 is a financial exchange and is a computational exchange comprised of computing apparatus, illustrated by dashed blocks, which support a digital trading platform 18 on which traders 17a, 17b, and 17c can make buy and sell offers in relation to tradeable units of tradeable assets listed on the exchange. The tradeable units are any type of tradeable unit and may include securities (e.g. shares in a company, financial instruments), commodities (e.g. iron ore, wheat), foreign exchange, futures, options contracts, etc. The second exchange 50 is a distributed ledger such as a blockchain, comprised of distributed computing apparatus illustrated as dashed blocks, which supports a trading platform 52 for trading of tokens such as cryptocurrency, cryptographic tokens, and digital assets by traders 54a, 54b, and 54c.

The interface system 20 is also a computational system comprised of computing apparatus, illustrated by dashed blocks, which is configured to implement a method for interfacing a digital financial exchange 10 and a distributed ledger system 50. FIG. 2 is a flowchart illustrating the implemented method. For simplicity a single financial exchange 10 and distributed ledger 50 are illustrated, but it will be understood that the interface system is configured to interact between multiple financial exchanges and multiple distributed ledgers 50. The distributed ledger 50 may or may not have an automated match-making functionality to match or link buyers and sellers of tokens.

An asset owner 11 lodges a request 12 to list an asset on the financial exchange 10 which reviews and processes the asset listing request 13. This request will contain the required regulatory and documentary evidence to support the listing, including the number of trading units 16 to be issued for subsequent trading on the trading platform 18. Once the listing request is reviewed and approved and the financial exchange issues 15 the requested number (N) of trading units 16 for trading on the trading platform 18, An approved listing request 14 is also sent to a token generation and pairing module 22 of the interface system 20 and comprises details of the listing including the number of trading units (N), the asset and asset owner. The generation and pairing module 22 of the interface system 20 processes this information and is configured to generate 23 a plurality of tokens 26 in the distributed ledger 50 in response to the listing request 14. The number of tokens 26 to be generated is equal to the number of trading units to be issued on the financial exchange and included in the list request (i.e. N tokens are generated for N trading units). For example in the case of that the distributed system is the Ethereum blockchain (or based on the Ethereum blockchain), the token generation and pairing module 22 prepares an appropriately formatted request which is submitted to an ERC-20 Token Smart Contract stored on the Ethereum blockchain which triggers generation of the required number (N) of ERC-20 Tokens to the interface system 20. The token generation and pairing module 22 checks that N tokens are received, and creates a record of the generation of N trading unit token pairs 24. A master record of the total number of trading unit token pairs N_{Tot} is stored. This is initially N, and is updated if additional trading units and tokens are created and paired.

In some embodiments the trading units and tokens are both fungible, such that there is no unique identifier for an individual trading unit or individual token. In this case token generation and pairing module 22 maintains a record of the total number of paired tokens and trading units (i.e. N pairs). That is the pairing is a pairing of N trading units with N tokens (N pairings) and there is no direct mapping of an individual trading unit to an individual token. During trading a record of the total number of pairs is stored to ensure the correct number of trading units and tokens are in circulation on the respective trading exchanges. In one embodiment a Non Fungible Token (NFT) is created to record information regarding the total number of pairings N_{Tot}, and/or each time there is a creation of N pairings. For example an ERC 721 Smart Contract, or a smart contract based on this standard may be used. In one embodiment the pairing process uses a cryptographic function to generate a public signature for the total number of trading unit token pairings (N_{Tot}) that can be used to verify or authenticate that a quantity of the trading units or tokens that is released for trading is held in the custody. In some embodiments a hash may be taken based on the public information relating to the number of trading unit token pairs, and information known only to the interface system (e.g. a private key) and this hash is used in the verification or authentication.

In some embodiments each trading unit and each token have a unique identifier, in which case the token generation and pairing module 22, in addition to tracking to the total number of pairings, may create and store 1 to 1 pairings of a trading unit and token. These pairings maybe an association stored in a database or other data structure that associates a unique identifier of each trading unit, such as unique serial number generated by the financial exchange when issuing the trading unit 16, and a unique identifier of the token 26, such as the blockchain address or unique hash. In one embodiment a Non Fungible Token (NFT) is created to record information regarding the 1 to 1 pairings. For example an ERC 721 Smart Contract, or smart contract based on this standard may be used. In one embodiment the pairing process uses a cryptographic function to generate a public signature for each trading unit token pair that can be used to verify or authenticate that one of the pair of a trading unit or token that is released for trading is held in the custody. In some embodiments a hash may be taken based on the public information relating to the trading unit or token and information known only to the interface system (e.g. a private key) and this hash is used in the verification or authentication.

In this embodiment a quantity X of trading units 16 (although it could be a single trading unit) is released for trading on the trading platform 18 and the equivalent quantity X of associated paired tokens 26 are placed in a custody storage system 30 which is referred to simply as a custody. The custody securely stores the X tokens 26 to prevent trading of the X tokens whilst the X paired trading units 16 are available for trading on the trading platform 18 (i.e. are in circulation). That is the X tokens 26′ are locked away, designated by a closed padlock in FIG. 1. This may comprise storing the secret key (or hash) required to transfer the token. The quantity X may be the number of trading units created (X=N), in which case all trading units are released for trading and no tokens are released. In an alternative embodiments a first portion M (M<N) of the created trading units are released for trading and M tokens are held in custody, whilst the remaining (or second) portion, M−N, of the trading units are placed in custody and (M−N) tokens are released for trading on the second exchange. At a later time point, the asset holder 11 or the current holder of the trading unit may wish to cease trading of quantity Y of the trading units 16 (which may be all of the trading units, that is Y=X) on the financial exchange, and instead wish to trade an equivalent number of tokens, Y on the distributed ledger 50. The interface system 20 (or the custody 30) implements a platform switch interface 40 which receives platform switching requests for the trading unit or trading unit token pair. Further trading of the quantity Y of trading units 16 is locked or halted, (or otherwise prevented), and the Y trading units 16 are placed in custody 42. This is illustrated in FIG. 1 as the unlocked padlock representing a trading unit 16 changing to a locked padlock 16′. This may comprise storing a digital issuing certificate, password, or hash used to verify ownership of the trading unit. The platform switching interface 40 retrieves the quantity Y of the paired locked tokens 26′ from the custody 30 and releases the equivalent Y tokens from the custody 43 to allow trading on the trading platform 52 of the distributed ledger 50. This is illustrated in FIG. 1 as the locked padlock 26′ changing to unlocked padlock 26. At a later time point, the asset holder 11 or the current holder of the trading unit may wish to cease trading a quantity Z of the tokens 26 on the distributed ledger, and instead wish to trade again on the financial exchange (Z may be all tokens, that is Z=Y=X=N). A further platform switching request is then made to the platform switch interface 40. The quantity of Z tokens 26 are then placed in custody 45 to prevent further trading on the distributed ledger 50, illustrated as unlocked padlock 26 changing to a locked padlock 26′ in FIG. 1. The quantity Z of locked trading units 16′ is then effectively retrieved from the custody storage 30 and the Z unlocked trading units 16 are released back onto the trading platform 18, illustrated in FIG. 1 as the locked padlock 16′ changing to an unlocked padlock 16. It will be understood that placing and retrieving locked trading units or tokens from custody may comprise updating the total of the number of trading units held in custody and total number of tokens held in custody. As discussed above, an NFT may be used to record the transfer, and quantity of transfer of trading units and tokens into/out of custody.

The platform switching request may be made by the current holder of a quantity of tradeable units or tokens (including a single trading unit or token), or the original issuer or asset holder may make the platform switching request. In some embodiments a platform switching request may be first verified and approved before it is actioned. For example a reviewer may check details of the requester to ensure they are authorized to make the request and have all the required information, and the information is valid. In some embodiments, once a platform switching request is received, for example for a trading unit that is being traded on the financial exchange, a request is sent to the exchange to halt trading of the Z trading units on the exchange. The quantity of trading units (Z) are placed in the custody and the associated quantity of tokens (Z) are released from the custody only once confirmation of halting of the quantity of the trading of the trading unit is received from the first trading exchange. This is not necessarily a complete trading halt of the security, but may simply be an acknowledgement from the trading exchange that the total volume of trading units for trading has been reduced by the quantity Z (i.e. Z trading units have effectively been reserved or withdrawn from trading). The trading platform of the distributed ledger (or second exchange) may then be notified that Z tokens are now available for trading. The trading platform may send an acknowledgement of the notification.

A similar approach can be used for transferring tokens being traded on the trading platform of the distributed ledger (or second exchange). A token holder will make a request to bring a second quantity of tokens to the first exchange to the platform switch interface 40. As the second exchange may be a decentralized (i.e. blockchain/distributed ledger system) the request may be a direct on blockchain request from the holder of the token, or via a software trading interface the holder is using. A smart contract on the blockchain may be used to receive the user request with execution of the smart contract initiating a platform switching request to the platform switch interface 40. In response to receiving a platform switching request for a second quantity of tokens of the trading unit token pairs that is being traded on the second exchange, a request is made to the first exchange for the switch from tokens to trading units and once confirmation is received from the first exchange, the second quantity of tokens are placed in custody and the second quantity of trading units are released from custody for trading on the first exchange by the token holder who becomes the holder of the trading units on the first exchange. The token holder will not necessarily be a client of the first exchange (although they may be). In this case a request to bring the second quantity of tokens back to the first exchange for conversion will be subject to the internal processes of the first exchange to accept the token holder, such as identity verification, token validation, etc. Once done, the first exchange will approve the conversion and notify the platform switch interface 40 of the approval enabling release of the second quantity of trading units from custody and placing the second quantity of tokens into custody.

The interface system 20 is configured to provide interfaces and hardware to allow cross platform trading of assets between the two platforms to effectively link the two separate platforms. It can thus be understood that the trading unit and token in a pair are interchangeable with only one of the pair being traded at any one time whilst allowing the exchange of one for the other on the relevant platform. Typically there are a quantity of pairs, and thus the interface system 20 ensures that the correct respective quantities of trading units and tokens are stored in the custody to ensure that, in effect, only one of each pair is being traded at any one time for all pairs (i.e. the quantity of pairs). The above example shows the case of the quantity N of trading units being released for trading after issuance. However it will be understood that more generally the interface system allows a decision on which part of a trading unit token pair to trade at any point in time, or rather the portion of the total number of pairings that are being traded as trading units, and the remaining portion that are being traded as tokens. That is when multiple trading units are issued, some or even all could immediately be placed in the custody and the associated tokens released to the distributed ledger. That is for N trading units issued, M (<N) could be released on the trading platform 18 and the remaining M−N trading units placed in custody whilst the associated M−N tokens are released onto the trading platform 52 of the distributed ledger 50. The platform switch interface then provides an interface to easily allow switching of which platform the relevant component of a trading unit token pair, and tracks the total number of trading units and token units being traded on the respective platforms, and ensures the sum equals the total number of trading unit token pairs.

In the above example, the first exchange 10 was a financial exchange and the second exchange 50 was a distributed ledger such as a blockchain. However it will be realized that the method can be extended to any type of exchange. For example in one embodiment the first exchange 10 and second exchange 50 could both be distributed ledgers such as Ethereum and Bitcoin network. In this embodiment the tradeable units and tokens are both digital tokens generated by the relevant distributed ledger or blockchain. The listing process and generation of tokens may be an automated process formed by a smart contract. In some embodiments the listing process may be a verified process, in which a third party verifies or digitally signs information in a listing request, or may be the party that initiates execution of the smart contract to generate the tokens. In another embodiment the first exchange 10 and second exchange 50 could both be financial exchanges. In this embodiment the system interface 20 may comprise or have access to a distributed ledger or blockchain on which details of listings and pairings of trading unit token pairs is recorded, along with platform transfer requests.

A general method 100 is defined for interfacing a first exchange 10 and a second exchange 50. A flowchart of an embodiment of this method 100 is illustrated in FIG. 2. At step 110 a plurality of trading units 16 for trading on a first exchange 10 and a plurality of tokens 26 for trading on a second exchange 50 are generated, and the plurality of trading units are paired with the plurality of tokens to create a plurality of trading unit token pairs. That is there is a 1 to 1 mapping of the quantity of trading units to the quantity of tokens so there is in effect a 1:1 mapping of each trading unit to each token. There may also be a direct 1 to 1 mapping of each trading unit to each token. If there are N trading units there are also N tokens and N trading unit token pairs. At step 120, for each of the plurality of trading unit token pairs, either the token 26 is placed in a custody 30 to allow trading of the paired trading unit 16 on the first exchange 10 or the trading unit 16 is placed in a custody 30 to allow trading of the paired token 26 on the second exchange 50. At step 130, one or more platform switching requests are received for a trading unit token pair. For each trading unit token pair it is determined whether the trading unit 16′ is in the custody 30 or the token 26 is in the custody 30. This information may be included in the platform switching request. If the token 26 is in the custody 30 then the associated trading unit 16 is placed in the custody and the token 26 is released for trading on the second exchange 50. If the trading unit 16 is in the custody then the associated token 26 is placed in the custody and the trading unit 16 is released for trading on the first exchange 10.

In one embodiment either the first exchange or the second exchange is an Ethereum blockchain and the tokens are ERC-20 tokens generated by ERC-20 Token Smart Contract or a Smart Contract compliant with the ERC-20 Token standard. For example the smart contract could be written to require information on the trading unit the token (or tokens) are to be paid with, or the underlying asset, a listing approval or other relevant information.

In one embodiment the custody storage system (or simply custody) is a database or similar data storage device which is configured, for example through software, to store records on the trading unit token pairs, including the quantities of tradeable units and quantity of tokens in the custody based on the total number of pairs, and effectively which member of each pair is in the custody, or a link or reference to a storage location of the trading unit or pair. In some embodiments the custody storage system 30 includes a cold wallet 32 to allow offline storage of the token 26 or trading unit 16. The cold wallet 32 may be periodically connected to the interface system 20 to allow transfer of tokens to the cold wallet and to allow removal of tokens from the cold wallet, or updating of the respective numbers of tradeable units and tokens in the custody. Thus as new listings or platform transfer requests are received the cold wallet is connected to allow transfers into and out of the cold wallet, including updating of the records, after which the cold wallet is disconnected from the custody storage system 30 or network. In one embodiment a cryptographic function is used to generate a public signature for each token or trading unit held in custody which is used to verify or authenticate that the pair of a trading unit or token that is released for trading is held in the custody. In one embodiment, for example, the cryptographic function could be one way hash function (e.g. those based on SHA, or DSA algorithms and standards) which generates a hash based on the token or tradeable unit. For example the cryptographic function could be a hashing function that generates a hash using a serial number of a trading unit and a private key of a token and a nonce, such as time of generation. Given one part of the pair the hash can be used to verify the other part of the pair is held in custody.

In some embodiments a NFT or digital twin may be created in relation to the asset to record information relating to the asset and issuances of trading units and tokens. An NFT may be created in relation to each pairing of trading units and tokens. In one embodiment a Non Fungible Digital Twin (NFDT) is used to represent the asset. In contrast to an NFT which is static representation of a digital asset, an NFDT is a dynamic digital representation of an asset which chains multiple records together.

The NFDT can be generated according to the following method. First an information package is generated and stored at a report address, wherein the information package comprises information defining a digital twin of an asset including at least one attribute value. The information package is cryptographically signed and a hash for authenticating the information package is obtained. Then, a birth asset smart contract is generated by inputting at least an asset identifier, the report address, and the hash of the information package to an asset smart contract stored on a blockchain which publishes the birth asset smart contract to the blockchain at a birth address and contains at least the inputted information and a non fungible token generated by the asset smart contract. Then, at least one subsequent information package is generated and stored at a subsequent report address, wherein each subsequent information package comprises information regarding the asset including either a change in the at least one attribute value of the asset, or a current value of the at least one attribute value where each subsequent information package is generated at a different time. Each subsequent information package is cryptographically signed and a hash for authenticating the subsequent information package is obtained. Then plurality of subsequent asset smart contracts are generated by inputting, for each subsequent information package, at least an asset identifier, the subsequent report address, and the hash of the subsequent information package to the asset smart contract stored on a blockchain which publishes a subsequent asset smart contract to the blockchain at a subsequent address and contains at least the inputted information, a non fungible token generated by the asset smart contract and a link to an address on the blockchain of a previous asset smart contract or the birth asset smart contract such that the published birth smart contract and one or more subsequent asset contracts form a time series of asset smart contracts which define a unique Non-Fungible Digital Twin (NFDT) representation of the asset.

In this context a birth smart contract is used to record initial details of the asset to be listed including the number of tradeable units (and tokens) to be generated. The quantity of trading unit token pairs, and the respective portions of the trading units and tokens to be stored in the custody may also be written in the birth contract, or subsequent contract may be executed when they are added to the custody. As platform switch requests are received, a subsequent smart contract is executing using an information package that include updates on what quantity of tokens or tradeable units are to be placed in custody and thus what quantity are to be removed. In this way an NFDT of the tradeable asset can be maintained by the interface system 20 to record the transaction history of the listed asset, including which the respective quantities of the tradeable units and tokens which are is being traded (and where) and which are in custody. This information may be used to verify that the correct number of tradeable units are being traded on the first platform and the correct number of tokens are being traded on the second platform. More details on embodiments of NFDTs are described in PCT Application No. PCT/SG2022/050242 titled “METHOD AND SYSTEM FOR CREATING NON-FUNGIBLE DIGITAL TWINS (NFDT) OF OBJECTS” filed on 21 Apr. 2022.

The interface system may be used for a wide range of assets and trading platforms. Whilst only two trading platforms is illustrated in FIG. 1, it will be understood that the system and method could be extended to multiple (e.g. more than 2) platforms. That is there could be a third, fourth, fifth, or more platforms, with the interface system 20 interfacing between all platforms and allow transfer of a trading unit to another platform.

As a further example to illustrate the method the case of a Hash Rate Backed Collective Investment scheme is considered. In this embodiment the tradeable unit is a called a HRBT001 unit which is a unit of an Open-ended Contractual Restricted Collective Investment Scheme backed by Non-Capital Market Products. The HRBT001 unit is traded on a digital trading exchange which is referred to as the MVGX platform. Each HRBT001 Unit is also simultaneously represented by a token, which is it's digital twin, which is generated by an ERC20 Smart Contract on the Ethereum Blockchain, and is backed by a Non-fungible Digital Twin (NFDT) of the underlying physical assets (discussed below). When HRBT001 is traded on MVGX platform, it is traded in its Unit format, and the corresponding Token is stored in MVGX's cold wallet as custody. When HRBT001 is traded outside MVGX platform on the Ethereum public blockchain on other platforms, it is traded in its Token format, with the corresponding Unit held by MVGX as the custodian for the Token Holders.

In this embodiment the issuer is a company set up a special purpose vehicle which holds a range of assets (or acquires from members that form the company) including mining rigs, hash rates, mining pools, income yield generated from the mined crypto assets. The mining rigs are used to mine cryptocurrencies and the like, to generate revenue from the mining activities. Each Unit or Token represents at least 0.1 TH/S (TH=total hash rate in tera-hashes per second averaged over previous 24 hours), plus fractional ownership of the underlying assets in the company. Sufficient assets are owned to generate at least 0.1 TH/S per Unit. Additional assets and revenue generated by mining activities can be returned to unitholders as dividends whilst some is retained for additional purchases of mining rigs and expenses. An NFDT is created which captures all the listing documents and relevant document relating to the scheme and company. Depending upon the number of assets available to the SPV company a number N of HRBT001 Units are created and N ERC-20 tokens are created on a blockchain and the NFDT and ERC-20 tokens are held in custody. The units are listed on MVGX exchange allowing investors to buy and sell units in the company. HRBT001 as a Unit or as a Token is interchangeable, with only one format being traded and the other format held by MVGX as custody. Ultimate token holders, subject to successful review, can bring the Token back to MVGX platform and exchange a Token for a Unit.

In another embodiment an asset backed security could be listed on a financial exchange. This may be a solar project, wind project, or carbon offsetting project which generates revenue through the generation and sale of carbon credits. Tradeable units of the asset are generated and listed on a financial exchange. A digital twin of the asset in the form of NFDT is also created on the Ethereum blockchain. The NFDT records the carbon credit (or carbon) neutrality status of the asset and generates tokens which can be traded on a trading platform or trading smart contracts on the Ethereum blockchain. The number of tokens generates is linked to the carbon credits (e.g. amount of emission reductions). Periodically (e.g. each month) a node is added to the NFDT capturing the carbon credits generated since the last node was added (e.g. in the previous month) and further tokens issued. Thus the number of asset backed tokens issued (both originally and each month) is linked to the carbon credit status. Similarly tradeable units are generated for trading on the financial exchange. A one to one mapping of the tokens to units on the financial exchange is maintained and the interface system of the present system is used to link the tradeable units and tokens and allow trading on either the financial exchange or blockchain.

In a further embodiment, an equity backed security could be listed on a financial exchange. In this embodiment, the tradeable unit is called an EBT (equity backed token) which is a unit of a contractual collective investment scheme backed by shares in an early stage company (e.g. a biotech company). Such tradeable units are traded on a digital trading exchange such as the MVGX platform. Each EBT Unit is also simultaneously represented by a token, which is its digital twin, which is generated by an ERC20 Smart Contract on the Ethereum Blockchain, and is backed by a Non-fungible Digital Twin (NFDT) of the underlying physical assets and which captures all the listing and relevant documents. When EBT is traded on MVGX platform, it is traded in its Unit format, and the corresponding Token is stored in MVGX's cold wallet as custodian. When EBT is traded outside MVGX platform on the Ethereum public blockchain or other platforms, it is traded in its Token format, with the corresponding Unit held by MVGX as the custodian for the token holders.

It will be understood that whilst there is a fixed total number of trading unit token pairs (i.e. N pairs), a portion of the pairs may be traded on the first exchange (i.e. M tradeable units) whilst a remaining portion of the pairs (N−M tokens) are traded on the second exchange. Further this will fluctuate over time as platform switching requests are made by tradeable unit holders and token holders. That is, the tradable units will continue to be traded on the first trading exchange even though some of the tradable units gets switched into tokens and are brought out of the first trading exchange and are traded on the second exchange. When the tradable units are initially issued and listed on the first exchange, the issuer of the trading unit sets the price for primary issuance. Thereafter, the market (via the trading platform on the first exchange) will set the trading price, based on the buy and sell orders of the participants on the platform. This similarly applies to the tokens being traded on the second trading exchange. As the first and second exchanges are separate, the value of a trading unit on the first exchange is not directly linked to the value of a token on the second exchange, and thus there may be a price divergence between value of the tradable unit on the first exchange and the value of a token on the second exchange. However it is likely that savvy traders would do a price arbitrage to minimize the price divergence gap, potentially through initiating a platform switching request, potentially to take advantage of an existing gap which would likely result in closing of the gap.

Embodiments of the above system and method provide an interface between financial exchanges and distributed ledgers and allow representation and trading of an asset on multiple platforms. Financial exchanges and distributed ledgers are both highly technical and complex computational systems which implement different computational architectures. Embodiments described herein provide technical solutions for providing an interface between these distinct computational systems creating an effective link to allow trading across the different exchanges/computational architectures. It also allows the same underlying asset to be able to benefit from the funding sources from the traditional financial industry through the first exchange and from the funding sources such as new money in the crypto world through the second exchange. Furthermore, it augments the liquidity of the trading assets and hence potentially enhance the valuation of the assets.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, middleware, platforms, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two, including cloud-based systems. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein, or a combination thereof. Various middleware and computing platforms may be used.

The interface system 20, trading exchange 10 and distributed ledger 50 (or any exchange) are all computational based systems using computing apparatus. The computing apparatus may comprise one or more processors including Central Processing Units (CPUs) and/or Graphical processing units (GPU) configured to perform some of the steps of the methods. A CPU may comprise an Input/Output Interface, an Arithmetic and Logic Unit (ALU) and a Control Unit and Program Counter element which is in communication with input and output devices through the Input/Output Interface. The Input/Output Interface may comprise a network interface and/or communications module for communicating with an equivalent communications module in another device using a predefined communications protocol (e.g. Bluetooth, Zigbee, IEEE 802.15, IEEE 802.11, TCP/IP, UDP, etc.). The computing apparatus may comprise a single CPU (core) or multiple CPU's (multiple core), or multiple processors. The computing apparatus is may be a server based computing apparatus or a cloud based computing apparatus using GPU clusters, but may be a parallel processor, a vector processor, or be a distributed computing device. Memory is operatively coupled to the processor(s) and may comprise RAM and ROM components, and may be provided within or external to the device or processor module. The memory may be used to store an operating system and additional software modules or instructions. The processor(s) may be configured to load and executed the software modules or instructions stored in the memory. The custody storage may comprise cold wallet storage devices including removable hard disks, USBs, mobile devices, etc. Applications or computer programs for executing on the apparatus may be written in a general-purpose programming languages (e.g., C, C#, C++, Java, Python, Swift, PHP, Ruby, Rust, Javascript, etc.) or specialized application-specific languages, including smart contract and blockchain languages or libraries such as Solidity, SmartPy, Bitscoin Scripting language, LLL, Vyper, etc., and may utilize or call software libraries or packages as required such as JSON. The operating system and application software may provide user interfaces.

Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

In one embodiment, a computer-readable storage medium is provided on which a computer program is stored, wherein the computer program implements the steps in each of the method embodiments described above when executed by a processor.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

Please note that the following claims are provisional claims only, and are provided as examples of possible claims and are not intended to limit the scope of what may be claimed in any future patent applications based on the present application. Integers may be added to or omitted from the example claims at a later date so as to further define or re-define the scope.

1-25. (canceled)

26. A method for providing a computational interfacing between a first exchange and a second exchange, comprising:
generating a plurality of trading units for trading on a first exchange and a plurality of tokens for trading on a second exchange, and pairing the plurality of trading units with the plurality of tokens to create a plurality of trading unit token pairs;
placing in a custody, for each of the plurality of trading unit token pairs, either the token to allow trading of the paired trading unit on the first exchange or the trading unit to allow trading of the paired token on the second exchange;
receiving one or more platform switching requests for a trading unit token pair and for each trading unit token pair determining whether the trading unit is in the custody or the token is in the custody, and if the token is in the custody then placing the associated trading unit in the custody and releasing the token for trading on the second exchange, and if the trading unit is in the custody then placing the associated token in the custody and releasing the trading unit for trading on the first exchange,
wherein the first exchange is a digital financial exchange and the plurality of trading units are N trading units which are generated in response to a listing request to list N trading units of a tradeable asset on the digital financial exchange, and approval of the listing request triggers generating N tokens on the second exchange.

27. The method as claimed in claim 26, wherein the second exchange is a distributed ledger and the plurality of tokens are N tokens generated by a smart contract executing on the distributed ledger.

28. The method as claimed in claim 26, wherein the second exchange is a distributed ledger and the plurality of tokens are N tokens generated by a smart contract executing on the distributed ledger in response to a first listing request to list N tokens of a tradeable asset on the distributed ledger, and approval of the listing request triggers generating N trading units on the first exchange.

29. The method as claimed in claim 28, wherein the first exchange is a digital financial exchange and a second listing request is made to the digital financial exchange to generate the N trading units for trading on the digital financial exchange.

30. The method as claimed in claim 26, wherein either the first exchange or the second exchange is an Ethereum blockchain and the tokens are ERC-20 tokens generated by ERC-20 Token Smart Contract or a Smart Contract compliant with the ERC-20 Token standard.

31. The method as claimed in claim 26, wherein pairing the plurality of trading units with the plurality of tokens to create a plurality of trading unit token pairs comprises pairing each token with one of the trading units.

32. The method as claimed in claim 26, wherein the custody comprises a cold wallet to store each token held in custody and each trading unit held in custody, and the custody uses a cryptographic function to generate a public signature for each token or trading unit held in custody which is used to verify that the pair of a trading unit or token that is released for trading is held in the custody.

33. The method as claimed in claim 28, wherein the method further comprises generating a NFDT on a distributed ledger to represent the tradeable asset, wherein the NFDT is configured to store a representation of the asset, a quantity of trading unit token pairs and a trading status for each trading unit token pair indicating which member of the pair is currently being traded, and the platform switching requests.

34. The method as claimed in claim 26, wherein in response to receiving a platform switching request for a first quantity of trading units of the trading unit token pairs that is being traded on the first exchange, a request is sent to the first exchange to lock trading of the first quantity of trading units on the first exchange, and once confirmation of locking of trading of the first quantity of trading units is received from the first trading exchange, the first quantity of the trading units are placed in the custody and the associated first quantity of tokens are released from the custody.

35. The method as claimed in claim 26, wherein in response to receiving a platform switching request for a second quantity of tokens of the trading unit token pairs that is being traded on the second exchange, a request is made to the first exchange for a switch from trading tokens to trading units and once confirmation is received from the first exchange the second quantity of tokens are placed in the custody and the second quantity of trading units are released from the custody for trading on the first exchange by the token holder who becomes the holder of the trading unit on the first exchange.

36. A computational system for interfacing a first exchange and a second exchange comprising a plurality of computing apparatus each comprising at least one memory and at least one processor, and a custody storage wherein the computational system is configured to:
generate a plurality of trading units for trading on a first exchange and a plurality of tokens for trading on a second exchange, and pairing the plurality of trading units with the plurality of tokens to create a plurality of trading unit token pairs;
store in the custody storage, for each of the plurality of trading unit token pairs, either the token to allow trading of the paired trading unit on the first exchange or the trading unit to allow trading of the paired token on the second exchange;
receive one or more platform switching requests for a trading unit token pair and for each trading unit token pair determining whether the trading unit is in the custody or the token is in the custody, and if the token is in the custody then placing the associated trading unit in the custody and releasing the token for trading on the second exchange, and if the trading unit is in the custody then placing the associated token in the custody and releasing the trading unit for trading on the first exchange,
wherein the first exchange is a digital financial exchange and the plurality of trading units are N trading units which are generated in response to a listing request to list N trading units of a tradeable asset on the digital financial exchange, and approval of the listing request triggers generating N tokens on the second exchange.

37. The computational system as claimed in claim 36, wherein the second exchange is a distributed ledger and the plurality of tokens are N tokens generated by a smart contract executing on the distributed ledger.

38. The computational system as claimed in claim 36, wherein the second exchange is a distributed ledger and the plurality of tokens are N tokens generated by a smart contract executing on the distributed ledger in response to a first listing request to list N tokens of a tradeable asset on the distributed ledger, and approval of the listing request triggers generating N trading units on the first exchange, and the first exchange is a digital financial exchange and a second listing request is made to the digital financial exchange to generate the N trading units for trading on the digital financial exchange.

39. The computational system as claimed in claim 36, wherein either the first exchange or the second exchange is an Ethereum blockchain and the tokens are ERC-20 tokens generated by ERC-20 Token Smart Contract or a Smart Contract compliant with the ERC-20 Token standard.

40. The computational system as claimed in claim 36, wherein pairing the plurality of trading units with the plurality of tokens to create a plurality of trading unit token pairs comprises pairing each token with one of the trading units.

41. The computational system as claimed in claim 36, wherein the custody storage comprises a cold wallet to store each token held in the custody storage and each trading unit held in the custody storage, and the custody is configured to use a cryptographic function to generate a public signature for each token or trading unit held in custody which is used to verify that the pair of a trading unit or token that is released for trading is held in the custody.

42. The computational system as claimed in claim 38, wherein the computational system is further configured to generate a NFDT on a distributed ledger to represent the tradeable asset, wherein the NFDT is configured to store a representation of the asset, a quantity of trading unit token pairs and a trading status for each trading unit token pair indicating which member of the pair is currently being traded, and the platform switching requests.

43. The computational system as claimed in claim 36, wherein in response to receiving a platform switching request for a first quantity of trading units of the trading unit token pairs that is being traded on the first exchange, a request is sent to the first exchange to lock trading of the first quantity of trading units on the first exchange, and once confirmation of locking of trading of the trading units is received from the first trading exchange, the first quantity of the trading units are placed in the custody and the associated first quantity of tokens are released from the custody.

44. The computational system as claimed in claim 36, wherein in response to receiving a platform switching request for a second quantity of tokens of the trading unit token pairs that is being traded on the second exchange, a request is made to the first exchange for a switch from trading tokens to trading units and once confirmation is received from the first exchange the second quantity of tokens are placed in the custody and the second quantity of trading units are released from the custody for trading on the first exchange by the token holder who becomes the holder of the trading unit on the first exchange.

45. A non-transitory computer readable medium comprising instructions for configuring a computational system to perform the method of claim 26.
